(19) United States
(12) Patent Application Publication
(10) Pub. No.: US 2012/0144948 A1
(43) Pub. Date: Jun. 14, 2012

(54) OPERATING APPARATUS FOR VEHICLE

(75) Inventors: Eunsik KIM, Daegu (KR); Jongho HONG, Seoul (KR); Jeehyuck CHOI, Hwaseong-si (KR); Jeongseon MIN, Hwaseong-si (KR); Yangrae CHO, Hwaseong-si (KR); Chunnyung HEO, Gyeongsan-si (KR); Kwanggi LEE, Daegu (KR); Dongjae KIM, Gyeongsan-si (KR)

(73) Assignees: SL Corporation, Dae-gu (KR); Hyundai Motor Company, Seoul (KR)

(21) Appl. No.: 13/247,409

(22) Filed: Sep. 28, 2011

(30) Foreign Application Priority Data
Dec. 9, 2010 (KR) 10-2010-0125410

(51) Int. Cl. F16H 59/02; B60G 17/015; B62D 1/12

(52) U.S. Cl. 74/473.33; 74/473.3; 74/471 R

(57) ABSTRACT

An operating apparatus for a vehicle facilitating a continuous operation may include a shift lever, a gate means providing a gate pattern and allowing the shift lever moving along a path to sequentially select a plurality of shift ranges and to make a continuous displacement in a specific shift range, actuators mounted in a vehicle to change physical quantities, and a controller controlling the actuators based on the continuous displacement made by the shift lever in the specific shift range. In addition, instead of letting the shift lever to make a continuous displacement in a specific shift range, the operating apparatus may include an additional independent operator to make the continuous displacement.

### CROSS-REFERENCE TO RELATED APPLICATIONS

The present application claims priority of Korean Patent Application Number 10-2010-0125410 filed Dec. 9, 2010, the entire contents of which application is incorporated herein for all purposes by this reference.

### BACKGROUND OF INVENTION

1. Field of Invention

The present invention relates to an operating apparatus for a vehicle, and more particularly, to a technology that can be used to control various devices as well as a transmission in a vehicle, by making it possible to select any one of several shift ranges, to make displacement due to continuous operations of a driver within the same shift ranges, and to detect the displacement due to the continuous operations.

2. Description of Related Art

Shifting devices of the related art are equipped with a shift lever to receive the intention of shift from a driver and makes it possible to select desired specific shift ranges by moving the shift lever in accordance with a gate pattern usually composed of P, R, N, and D, such that when a driver selects any one of the shift ranges, using the shift lever, a transmission is correspondingly controlled and a vehicle is driven.

Further, recently, since a gate pattern for a manual mode is added, as the shift lever is operated to M+ or M−, the transmission correspondingly increases or decreases the gear ratio by stages, thereby shifting.

According to the gate pattern of the related art described above, although any specific shift range can be selected by the shift lever, the intention of operation of a driver cannot be continuously received in the selected specific shift range.

That is, when the shift ranges, such as the P, R, N, and D-ranges, are selected by the shift lever, other operations, except for selecting any one shift range, cannot implemented. Further, a driver can only show the intention of operation by repeatedly selecting M+ or M− with the shift lever and the intention of continuous operation of the driver cannot be received, in the manual mode as well.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention have been made in an effort to provide an operating apparatus for a vehicle that makes it possible to select any one of a plurality of shift ranges in accordance with the intention of operation of a driver, allows the driver to additionally show the intention of continuous operation in a specific shift range, and makes it possible to implement desired control by detecting the intention of continuous operation and applying the intention of continuous operation of the driver to the other devices equipped in a vehicle as well as a transmission.

Some aspects of the present invention are directed to provide an operation apparatus for a vehicle, including a shift lever; a gate means that provides a gate pattern making it possible to sequentially select a plurality of shift ranges on the line of path of the shift lever by movement of the shift lever and set to be able to make continuous displacement of the shift lever for one specific shift range of the shift ranges; an actuator that is mounted in a vehicle to be able to change physical quantities; and a controller that controls the actuator on the basis of information on continuous displacement made by the shift lever in the specific one shift range.

Other aspects of the present invention are directed to provide an operation apparatus for a vehicle, including a shift lever that makes it possible to select a desired shift range in a plurality of shift ranges; an additional operator that makes continuous displacement independent from the shift lever; an actuator that changes physical qualities in a vehicle; and a controller that controls the actuator on the basis of information on the continuous displacement made by the additional operator, with the shift lever positioned at one specific shift range in the shift ranges.

According to the present invention, it is possible to select any one of a plurality of shift ranges in accordance with the intention of operation of a driver, allows the driver to additionally show the intention of continuous operation in a specific shift range, and makes it possible to implement desired control by detecting the intention of continuous operation and applying the intention of continuous operation of the driver to the other devices equipped in a vehicle as well as a transmission.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing an exemplary operating apparatus according to the present invention.

FIG. 2 is a diagram schemetically illustrating the configuration of the exemplary operating apparatus shown in FIG. 1.

FIG. 3 shows an exemplary gate pattern according to the present invention.

FIG. 4 shows another exemplary gate pattern according to the present invention.

FIG. 5 is a diagram showing an exemplary operating apparatus using a plurality of independent controllers.

FIG. 6 is a diagram showing another exemplary operating apparatus of the present invention.

FIG. 7 is a diagram showing various actuators that are controlled by a controller.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

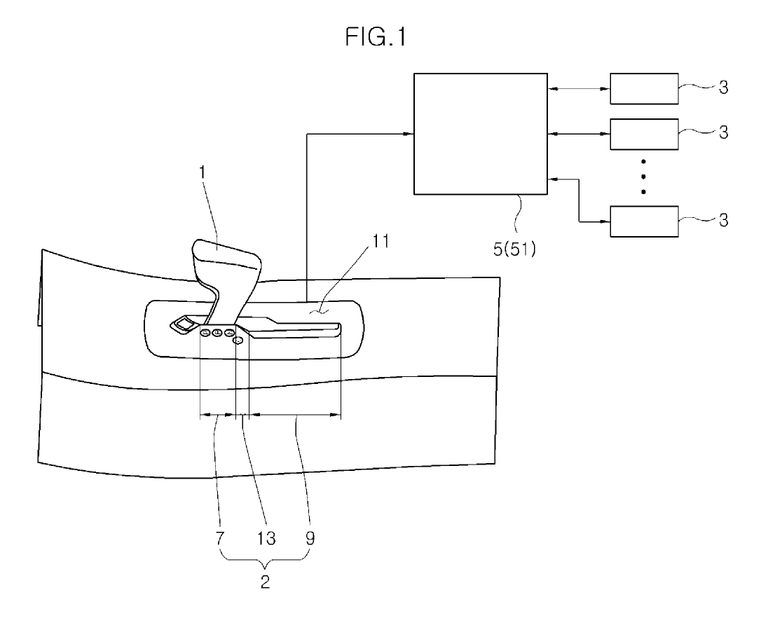

Referring to FIG. 1, exemplary embodiments of the present invention may include a shift lever 1; a gate means that provides a gate pattern 2 making it possible to sequentially select a plurality of shift ranges on the line of path of shift lever 1 by movement of shift lever 1 and set to be able to make continuous displacement of shift lever 1 for one specific shift range of the shift ranges; an actuator 3 that is mounted in a vehicle to be able to change physical quantities; and a controller 5 that controls actuator 3 on the basis of information on continuous displacement made by shift lever 1 in the one specific shift range.

That is, shift lever 1, similar to the configuration shift levers of the related art, allows for selecting a plurality of shift ranges, P, R, N, and D-ranges, while moving on a predetermined path and one specific shift range in the shift ranges is set to as the D-range in the exemplary embodiments, such that the shift range that has selected the D-range can make continuous displacement. Further, as the shift lever makes continuous displacement from the D-range, controller 5 can receive this information and control actuator 3.

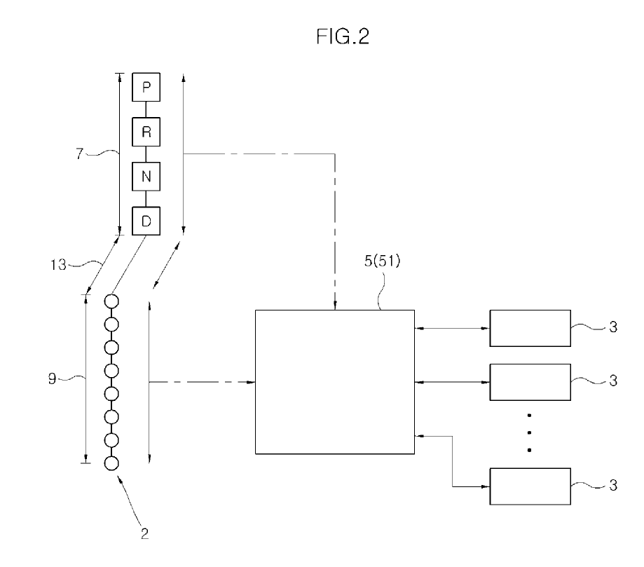

For reference, FIG. 2 is a diagram briefly illustrating the configuration of the exemplary embodiment shown in FIG. 1, in which as shift lever 1 moves along the path indicated by an arrow, information on the changing positions is inputted to controller 5, and controller 5 can control various actuators 3 in the vehicle, in addition to controlling a transmission, on the basis of the information.

In the exemplary embodiments, the gate means may include a gate plate 11 having a gate pattern 2 that includes a first section 7 with a plurality of sequentially disposed shift ranges and a second section 9 connected with first section 7 and allowing for continuous displacement of shift lever 1 for one specific shift range.

Obviously, the gate means may further include a mechanism, such as a guide, which allows shift lever 1 to move along gate pattern 2 and the mechanism can be implemented by various technologies. One of various technical features of the present invention is to make additional continuous displacement of shift lever 1, with a specific shift range selected as described above, and to provide information that can be used by the controller, by sensing the displacement.

In the exemplary embodiments, first section 7 is formed straight and second section 9 is formed to be discriminated from the straight line constructed by first section 7. Further, second section 9 deviates in a straight line from first section 7 while first section 7 and second section 9 are connected by a connecting section 13 formed at an angle with respect to first section 7 and second section 9.

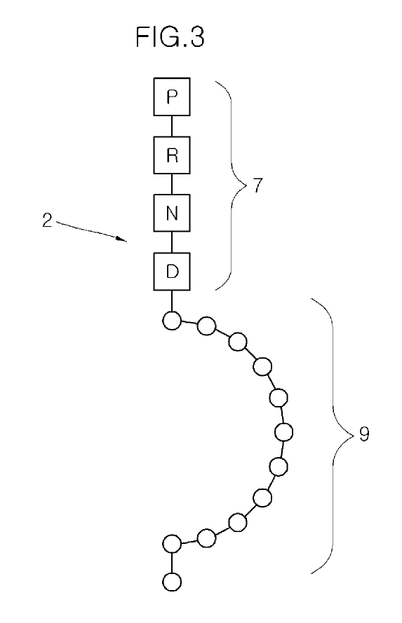

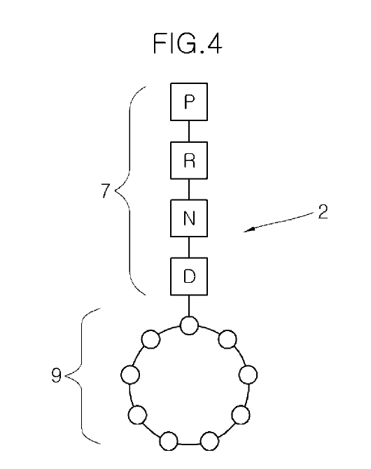

Obviously, instead of gate pattern 2 described above, as shown in FIG. 3, gate pattern 2 may be formed to have first section 7 that is the same as in the above-mentioned exemplary embodiments and second section 9 that is connected in a curve to one end of first section 7, or as shown in FIG. 4, gate pattern 2 may be formed to have second section 9 that is connected in a closed curve to one end of first section 7.

For reference, the continuous displacement of shift lever 1 is not only the displacement that is implemented in a way that shift lever 1 can continuously move and stop at any point, but may be the displacement that is implemented such that shift lever 1 moves to a plurality of sequential position spaced apart from each other.

The spaced positions are not provided to change and select desired shift ranges as in the related art, but used to provide a series of values such that a driver can show the level of controlling a specific shift range or a desired object to control in the vehicle.

For example, when the specific shift range is the D-range, assuming that, the displacement in second section 9 of shift lever 1 can be controlled such that when the side close to first section 7 implies so-called an eco-mode for selecting a shift pattern on the basis of fuel efficiency of the vehicle, the side far from first section 7 in second section 9 implies so-called a sporty mode for selecting a shift pattern on the basis of the driving force of the vehicle. Further, the displacement implies being able to adjust the suspensions of the vehicle to switch from soft riding comfort to hard riding comfort, as shift lever 1 moves away from first section 7.

The controller receives information on the continuous displacement made by shift lever 1 in one specific shift range and continuously controls the physical quantities that actuators 3 can adjust, to correspond to the continuous displacement of shift lever 1.

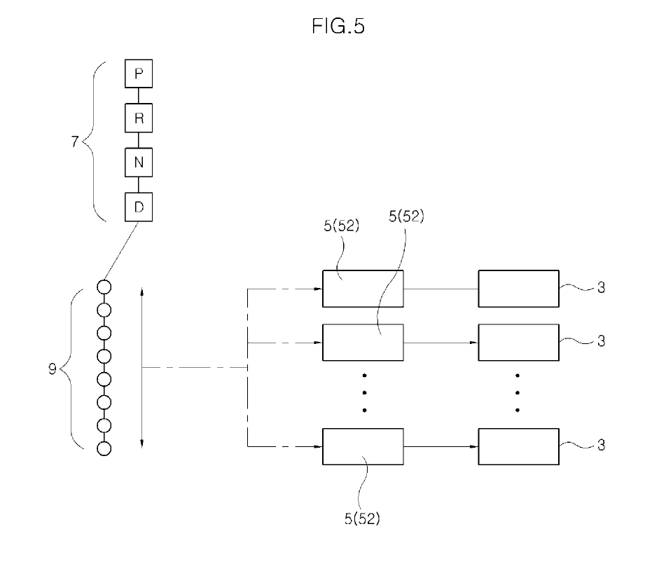

Controller 5 may be an integrated controller 51 that receives information on the continuous displacement made by shift lever 1 in a specific shift range and simultaneously controls various actuators 3 in the vehicle, as shown in FIG. 2, or may be composed of a plurality of independent controllers 52 that separately controls the same type of actuators 3 in the vehicle, as shown in FIG. 5.

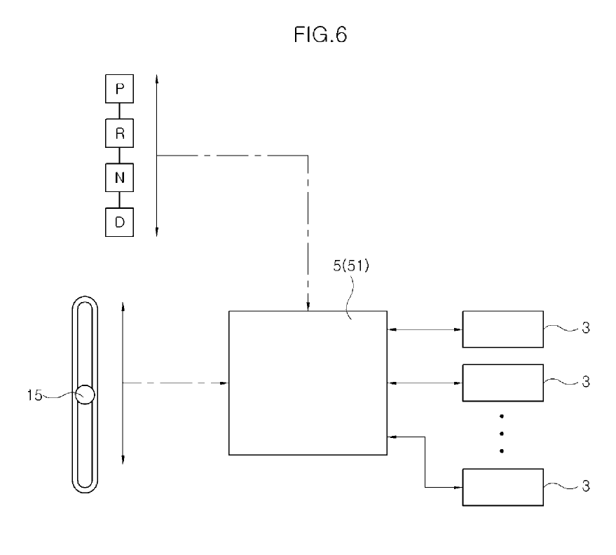

Further, other exemplary embodiments of the present invention, as shown in FIG. 6, may include a shift lever 1 that makes it possible to select a desired shift range in a plurality of shift ranges; an additional operator 15 that makes continuous displacement independent from shift lever 1; an actuator 3 that changes physical qualities in a vehicle; and a controller 5 that controls actuator 3 on the basis of information on the continuous displacement made by additional operator 15, with shift lever 1 positioned at one specific shift range in the shift ranges.

The one specific shift range where shill lever 1 is positioned to control actuator 3 on the basis of the information on the continuous displacement made by additional operator 15 is the D-range in the exemplary embodiments where the vehicle travels.

Controller 5 receives information on the continuous displacement made by additional operator 15 and continuously controls the physical quantities that actuators 3 can adjust, to correspond to the continuous displacement of additional operator 15.

Obviously, controller 5 may be an integrated controller 51 that receives information on the continuous displacement made by additional operator 15 and simultaneously controls various actuators 3 in the vehicle, or may be composed of a plurality of independent controllers 52 that separately controls the same type of actuators 3 in the vehicle.

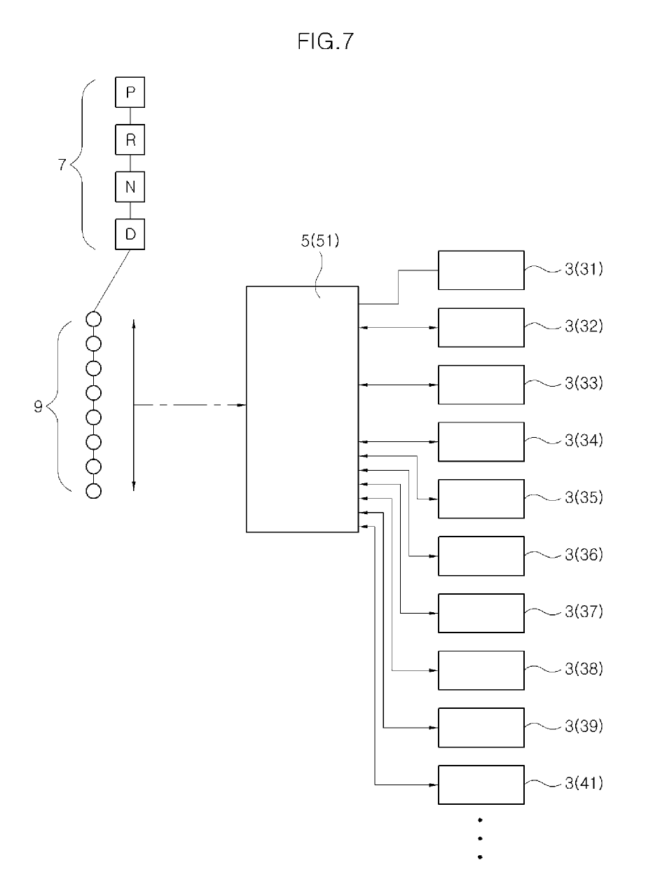

As shown in FIG. 7, actuator 3 may include a steering device 31 that provides a function of steering the vehicle, in which controller 5 may control steering device 31 such that supplement force for the steering force of the driver changes, corresponding to the information on the continuous displacement of shift lever 1.

That is, when shift lever 1 makes additional continuous displacement in the D-range, the displacement increases and the supplement force for the steering force gradually decreases, such that steering device 31 is controlled such that the steering wheel is operated with larger force by the driver. Obviously, in contrast to the above, it may be possible that the larger the continuous displacement of shift lever 1, the more the supplement force gradually increases.

Further, actuator 3 may include a level adjustment device 32 of the suspension of the vehicle and controller 5 may control level adjustment device 32 such that the height of the vehicle changes, in response to the information on the continuous displacement.

That is, as shift lever 1 is positioned at the D-range and the continuous displacement is further increased, controller 5 can gradually decrease the height of the vehicle which has been increased, by receiving information on the continuous displacement additionally made by shift lever 1 in the D-range and controlling level adjustment device 32 to correspond to the information, or may gradually increase the height of the vehicle.

Further, actuator 3 may include a variable damping system 33 of the suspension of the vehicle and controller 5 may control variable damping system 33 such that the damping force of the suspension of the vehicle changes, in response to the information on the continuous displacement.

Therefore, actuator 3 can gradually switch the suspension of the vehicle from the soft state to the hard state, or vice versa, in accordance with the displacement of shift lever 1, by receiving the additional continuous displacement made by shift lever 1 in the D-range and controlling variable damping system 33 to correspond to the displacement of shift lever 1 such that the damping force of the suspension of the vehicle can change.

Further, actuator 3 may include a transmission 34 of the vehicle and controller 5 may control transmission 34 by changing the condition for changing the gear ratio of transmission 34, in response to the information on the continuous displacement.

Therefore, when shift lever 1 is positioned at the D-range, in a range with relatively small continuous displacement, transmission 34 is controlled in a shift pattern that can implement an eco-mode on the basis of fuel efficiency of the vehicle, and as the continuous displacement of shift lever 1 increases, transmission 34 is controlled in a shift pattern that can implement a sports mode on the basis of the driving force of the vehicle, such that the user can select preferring taste in a continuous range.

Actuator 3 may include a cluster 35 of a vehicle and controller 5 may control cluster 35 such that the lighting brightness of cluster 35 changes, corresponding to the information on the continuous displacement and control cluster 35 such that the lighting color of cluster 35 changes.

Therefore, controller 5 can slowly change the lighting brightness of cluster 35 from a dark state to a bright sate and vice versa in accordance with the magnitude of the additional continuous displacement made by shift lever 1 in the D-range, and control cluster 35 such that lighting color gradually changes.

That is, the change in physical quantity by the actuator in the exemplary embodiments is a concept including not only changes in single physical quantity, such as the lighting brightness, but continuous interactive changes in similar physical quantities, such as the change in lighting color of the cluster from a color to another color.

Further, actuator 3 may include a lighting device 36 of the vehicle and controller 5 may control lighting device 36 such that the lighting brightness changes, in response to the information on the continuous displacement.

Therefore, controller 5 can make the lighting of the vehicle brighter or darker, in accordance with the magnitude of the additional continuous displacement made by shift lever 1 in the D-range.

Further, actuator 3 may include an audio device 37 of the vehicle, in which controller 5 may control audio device 37 such that the volume of audio device 37 changes, in response to the information on the continuous displacement.

Therefore, controller 5 can gradually increase or decrease the volume of audio device 37, in accordance with the magnitude of the additional continuous displacement made by shift lever 1 in the D-range.

Further, actuator 3 may include an air conditioner 38 of the vehicle and controller 5 may control air conditioner 38 such that the amount of air sent by air conditioner 38 changes, in response to the information on the continuous displacement.

Therefore, controller 5 can gradually increase or decrease the amount of air sent by air conditioner 38, in accordance with the magnitude of the additional continuous displacement made by shift lever 1 in the D-range.

Further, actuator 3 may include an overspeed alarm 39 of the vehicle and controller 5 may control overspeed alarm 39 by changing reference speed for overspeed alarm 39 to determine overspeed, in response to the information on the continuous displacement.

Therefore, controller 5 can make the vehicle speed where the driver is informed of overspeed by operating overspeed alarm 39, in accordance with the magnitude of the additional continuous displacement made by shift lever 1 in the D-range. For example, if overspeed alarm 39 is operated to warn the driver, it warns the driver when the vehicle speed becomes relatively high speed in a range with large additional displacement of shift lever 1.

Actuator 3 may include an engine 41 and a transmission 34 of a vehicle and controller 5 can control engine 41 and transmission 34 such that the operation of the vehicle switches from the eco-mode that is a fuel saving mode to the sport mode to provide the driver with sporty feel, in response to the information on the continuous displacement.

Therefore, controller 5 continuously changes the traveling mode of the vehicle by simultaneously controlling engine 41 and transmission 34 such that the vehicle that has traveled in the eco-mode travels in the sport mode, in accordance with the magnitude of the additional continuous displacement made by shift lever 1 in the D-range. Obviously, the exemplary embodiments described above exemplify only various representative embodiments that can be implemented in a vehicle, in which, as described above, when a specific shift range is selected by shift lever 1 or additional operator 14 and additional continuous displacement is generated, various actuators 3 that can control various variable physical quantities of the vehicle by receiving the information on the additional displacement, such that the driver can control independently or in a desired combination the various physical quantities including the exemplary embodiments described above, only by operating shift lever 1 or additional operator 15.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An operation apparatus for a vehicle, comprising:
a shift lever;
a gate means providing a gate pattern and allowing the shift lever moving along a path to sequentially select a plurality of shift ranges and to make a continuous displacement in a specific shift range;
an actuator mounted in a vehicle to change physical quantities; and
a controller controlling the actuator based on the continuous displacement made by the shift lever in the specific shift range.

2. The operation apparatus for a vehicle as defined in claim 1, wherein the gate means includes a gate plate having the gate pattern that includes a first section with a plurality of the sequentially disposed shift ranges and a second section connected with the first section and allows for the continuous displacement made by the shift lever in the specific shift range.

3. The operation apparatus for a vehicle as defined in claim 2, wherein the first section is formed straight and the second section is discriminated from a straight line constructed by the first section.

4. The operation apparatus for a vehicle as defined in claim 3, wherein the second section deviates in a straight line from the first section while the first section and the second section are connected by a connecting section formed at an angle with respect to the first section and the second section.

5. The operation apparatus for a vehicle as defined in claim 3, wherein the second section is formed in a curve connected to one end of the first section.

6. The operation apparatus for a vehicle as defined in claim 5, wherein the second section is formed in a closed curve connected to one end of the first section.

7. The operation apparatus for a vehicle as defined in claim 1, wherein the specific shift range set to allow the shift lever to make the continuous displacement is a D-range for driving the vehicle.

8. The operation apparatus for a vehicle as defined in claim 1, wherein the controller receives information on the continuous displacement made by the shift lever in the specific shift range and continuously controls the actuator to adjust the physical quantities corresponding to the continuous displacement made by the shift lever.

9. The operation apparatus for a vehicle as defined in claim 1, wherein the actuator is composed of a plurality of actuators, and the controller is an integrated controller that receives information on the continuous displacement made by the shift lever in the specific shift range and simultaneously controls a plurality of the actuators.

10. The operation apparatus for a vehicle as defined in claim 1, wherein the actuator is composed of a plurality of actuators, and the controller is composed of a plurality of independent controllers that receive information on the continuous displacement made by the shift lever in the specific shift range and separately controls one or more of a plurality of the actuators.

11. An operation apparatus for a vehicle, comprising:
a shift lever possible to select a desired shift range in a plurality of shift ranges;
an additional operator making a continuous displacement independent from the shift lever;
an actuator changing physical qualities in a vehicle; and
a controller controlling the actuator based on the continuous displacement made by the additional operator, with the shift lever positioned in a specific shift range of the shift ranges.

12. The operation apparatus for a vehicle as defined in claim 11, wherein the specific range where the shift lever is positioned to control the actuator based on the continuous displacement made by the additional operator is a D-range for driving the vehicle.

13. The operation apparatus for a vehicle as defined in claim 11, wherein the controller receives information on the continuous displacement made by the additional operator and continuously controls the actuator to adjust the physical quantities corresponding to the continuous displacement of the additional operator.

14. The operation apparatus for a vehicle as defined in claim 11, wherein the actuator is composed of a plurality of actuators, and the controller is an integrated controller that receives information on the continuous displacement made by the additional operator and simultaneously controls a plurality of the actuators.

15. The operation apparatus for a vehicle as defined in claim 11, wherein the actuator is composed of a plurality of actuators, and the controller is composed of a plurality of independent controllers that receive information on the continuous displacement made by the additional operator and separately controls one or more of a plurality of the actuators.

16. The operation apparatus as defined in claim 11, wherein the actuator includes a steering device that provides a function of steering the vehicle and the controller controls the steering device such that supplement force for the steering force of the driver changes, corresponding to the information on the continuous displacement.

17. The operation apparatus for a vehicle as defined in claim 11, wherein the actuator includes a level adjustment device of the suspension of the vehicle and the controller controls the level adjustment device such that the height of the vehicle changes, in response to the information on the continuous displacement.

18. The operation apparatus for a vehicle as defined in claim 11, wherein the actuator includes a variable damping system of the suspension of the vehicle and controller controls the variable damping system such that the damping force of the suspension of the vehicle changes, in response to the information on the continuous displacement.

19. The operation apparatus for a vehicle as defined in claim 11, wherein the actuator includes a transmission of the vehicle and the controller controls the transmission by changing the condition for changing the gear ratio of the transmission, in response to the information on the continuous displacement.

20. The operation apparatus for a vehicle as defined in claim 11, wherein the actuator includes a cluster of the vehicle and the controller controls the cluster such that the lighting brightness of the cluster changes, corresponding to the information on the continuous displacement.

21. The operation apparatus for a vehicle as defined in claim 11, wherein the actuator includes a cluster of the vehicle and the controller controls the cluster such that the lighting color of the cluster changes, corresponding to the information on the continuous displacement.

22. The operation apparatus for a vehicle as defined in claim 11, wherein the actuator includes a lighting device of the vehicle and the controller controls the lighting device such that the lighting brightness changes, in response to the information on the continuous displacement.

23. The operation apparatus for a vehicle as defined in claim 11, wherein the actuator includes an audio device of the vehicle and the controller controls the audio device such that the volume of the audio device changes, in response to the information on the continuous displacement.

24. The operation apparatus for a vehicle as defined in claim 11, wherein the actuator includes an air conditioner of the vehicle and the controller controls the air conditioner such that the amount of air sent by the air conditioner changes, in response to the information on the continuous displacement.

25. The operation apparatus for a vehicle as defined in claim 11, wherein the actuator includes an overspeed alarm of the vehicle and the controller controls the overspeed alarm by changing reference speed for the overspeed alarm to determine overspeed, in response to the information on the continuous displacement.

26. The operation apparatus for a vehicle as defined in claim 11, wherein the actuator includes an engine and a transmission of a vehicle and the controller controls the engine and the transmission such that the operation of the vehicle switches from an eco-mode that is a fuel saving mode to a sport mode to provide the driver with sporty feel, in response to the information on the continuous displacement.
